(19) United States
(12) Patent Application Publication
(10) Pub. No.: US 2023/0359998 A1
(43) Pub. Date: Nov. 9, 2023

(54) AUTOMATED COLLABORATIVE MANAGEMENT FRAMEWORK USING MACHINE LEARNING MODELLING AND FORECASTING

(71) Applicant: Eyitayo Olaoluwa Koleoso, Silver Spring, MD (US)

(72) Inventor: Eyitayo Olaoluwa Koleoso, Silver Spring, MD (US)

(21) Appl. No.: 18/222,111

(22) Filed: Jul. 14, 2023

Related U.S. Application Data
(63) Continuation-in-part of application No. 17/301,781, filed on Apr. 14, 2021.

(51) Int. Cl. G06Q 10/10

(52) U.S. Cl. CPC G06Q 10/103

(57) ABSTRACT

A collaborative production management system includes a digital user interface accessible by end users associated with an organization. User defined parameters of a collaborative project outcome define sub-categories of attributes associated with a defined success metric of the collaborative project outcome. Input associated with a progression of work within one or more of the sub-categories of topics is received and continuously monitored. Operation of a machine learning module includes building a prediction model correlating a relationship of the attributes. A direction of the attributes is forecasted based on the prediction model and a current status of progression of work in each of the sub-categories. The current status of progression of work in each of the sub-categories, and the forecasted direction of the attributes is displayed.

### CROSS-REFERENCE TO RELATED APPLICATIONS

This application is a continuation-in-part and claims benefit under 35 U.S.C. § 119 of U.S. Non-Provisional Application No. 17/301,781 filed Apr. 14, 2021, which is hereby incorporated by reference herein in its entirety

### BACKGROUND OF THE INVENTION

The present disclosure relates to computing arrangements using knowledge-based models, and more particularly to, an automated collaborative management framework using machine learning modelling and forecasting.

Many organizations involved in collaborative product development struggle to produce products in a structured, repeatable, and predictable manner. The problem is one of management. With agile teams, for instance teams running the ‘Agile’ methodology of software development, the focus is usually on just the day-to-day feature work. This has the effect of neglecting the long-term, strategic view of delivering products and services; specifically, short-sighted management fails to clarify and identify ingredients that will yield predictable results in the future for similarly situated products and services. The crux of this problem is that current top-down management frameworks have only one demographic in mind: management.

Change that is driven by those that will implement the change—a bottom-up paradigm—tends to promote the participant's commitment and engagement, which in turn creates the expectation is that the ingredients are repeatable, durable fixtures that can be reused for multiple releases of product in the same organization. The top-down management approach, in contrast, tends to dictate the ‘what’ and ‘how’ in an unresponsive and delayed manner. Furthermore, under top-down regimes, often the direction produced is not typically repeatable in future, similarly situated efforts.

As can be seen, there is a need for a management framework for delivering products and services in an enterprise, whereby the method that embodies the management framework assigns the tactics (e.g., planning and implementation) to the employees and the strategies (e.g., guidance and enablement) to the employers. At the end, the present invention provides a practical implementation of management steps that transforms an enterprise's management framework into a nimble, decentralized innovative decision-making process that encourages employee engagement and encourage employer listening in an assembly-line approach to delivering features, products, and services.

The present invention, colloquially known as ‘Better Managed Development’ (BMD) inverts the employee-management relationship, having the employees do the creative thinking and most of the planning, while management maintains strategic guidance, provides resources and arbitrates disputes. BMD is a method by which leadership and employees can collaborate on a longer-term and sustainable method for delivering features, products and services repeatably into the future. It presents a structured method and process for identifying the ingredients desirable for efficient, predictable, and sustainable delivery of features, products and services.

The “bottom-up” management embodied in the present invention deliberately separates employer-management duties and employee-worker duties, fostering an environment where employees are expected to push up ideas and tactics, while management maintains strategic direction and enablement.

### SUMMARY OF THE INVENTION

In one aspect of the subject disclosure, a collaborative production management system is provided. The system includes a processor and a memory coupled to the processor. The memory includes program instructions stored thereon that, upon execution by the processor, cause the system to create a digital create a digital user interface accessible by a plurality of end users associated with an organization. User defined parameters of a collaborative project outcome are received from an administrative user of the organization. The parameters define sub-categories of attributes associated with a defined success metric of the collaborative project outcome. Input associated with a progression of work within one or more of the sub-categories of topics is received by the plurality of end users. The received input from the plurality of end users is continuously monitored. The received input from the plurality of end users is processed using a machine learning modelling module. An operation of the machine learning module includes building a prediction model correlating a relationship of the attributes. A direction of the attributes is forecasted based on the prediction model and a current status of progression of work in each of the sub-categories. The program instructions further cause the system to display on the digital user interface the current status of progression of work in each of the sub-categories, and the forecasted direction of the attributes.

In another aspect, a computer program product for providing collaborative production management in an organization is provided. The computer program product includes one or more computer readable storage media, and program instructions collectively stored on the one or more computer readable storage media. The program instructions include creating a digital create a digital user interface accessible by a plurality of end users associated with an organization; receiving, from an administrative user of the organization, user defined parameters of a collaborative project outcome, wherein the parameters define sub-categories of attributes associated with a defined success metric of the collaborative project outcome; receiving, by the plurality of end users, input associated with a progression of work within one or more of the sub-categories of topics; continuously monitoring the received input from the plurality of end users; processing the received input from the plurality of end users, using a machine learning modelling module, wherein an operation of the machine learning module includes: building a prediction model correlating a relationship of the attributes; and forecasting a direction of the attributes based on the prediction model and a current status of progression of work in each of the sub-categories; and wherein the program instructions further cause the system to display on the digital user interface: the current status of progression of work in each of the sub-categories, and the forecasted direction of the attributes

In yet another aspect, a method providing collaborative production management in an organization, includes: creating a digital create a digital user interface accessible by a plurality of end users associated with an organization; receiving, from an administrative user of the organization, user defined parameters of a collaborative project outcome, wherein the parameters define sub-categories of attributes associated with a defined success metric of the collaborative project outcome; receiving, by the plurality of end users, input associated with a progression of work within one or more of the sub-categories of topics; continuously monitoring the received input from the plurality of end users; processing the received input from the plurality of end users, using a machine learning modelling module, wherein an operation of the machine learning module includes: building a prediction model correlating a relationship of the attributes; and forecasting a direction of the attributes based on the prediction model and a current status of progression of work in each of the sub-categories; and wherein the program instructions further cause the system to display on the digital user interface: the current status of progression of work in each of the sub-categories, and the forecasted direction of the attributes.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention;

FIG. 2 is a diagrammatical view of an exemplary embodiment of a task total diagram of the present invention, illustrating a dynamic BMD Readiness Score plot;

FIG. 3 is a schematic view of an exemplary embodiment of a vision board application of the present invention; and

FIG. 4 is a continuation of FIG. 3.

FIG. 5 is a block diagram of a system for providing collaborative production management according to an embodiment.

FIG. 6 is a block diagram of an architecture implementing artificial intelligence and/or machine learning in a system for providing collaborative production management according to an embodiment.

FIG. 7 is a block diagram of an architecture for defining outcomes in a collaborative production management system, according to an embodiment.

FIG. 8 is a flowchart of a method for providing collaborative production management according to an embodiment.

FIG. 9 is a screenshot of an objectives user interface for a system for providing collaborative production management according to an embodiment.

FIG. 10 is a screenshot of a cultural flare user interface for a system for providing collaborative production management according to an embodiment.

FIG. 11 is an illustrative representation of a cultural alert user interface for a system for providing collaborative production management according to an embodiment.

FIG. 12 is a block diagram of a computing device consistent with embodiments.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a management framework for delivering products and services in an enterprise.

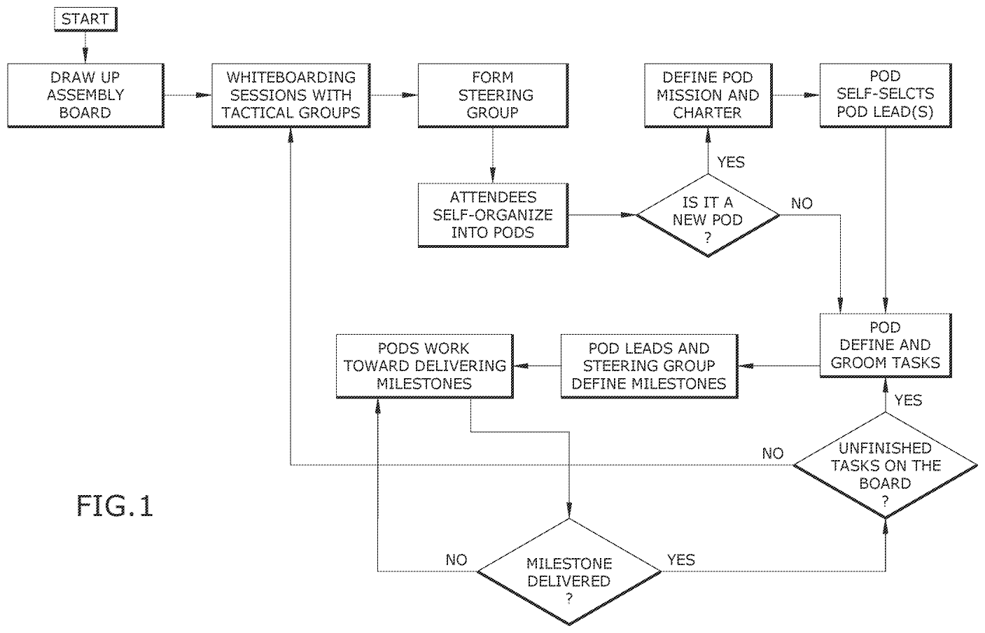

Referring now to FIGS. 1 through 4, the present invention in various embodiments may include the management framework for delivering products and services in an enterprise that is adapted to implement a number of systems and methods in the form of virtual whiteboarding applications, pod-forming applications, and tasking applications. The assets from the whiteboarding applications may be itemized as tasks in the tasking applications, wherein the itemized tasks are then split across the pods (previously formed through the podding applications).

In some embodiments, a method of the management framework may include creating a virtual collaboration workspace for a plurality of participants, wherein the plurality of participants may include tactical participants and strategical participants. Each of the participants may operate a device configured to access the workspace, the workspace including a tactical portion and a plurality of strategic portions, the tactical portion is read and write accessible to each tactical participant to the exclusion of the strategic participants' write access. Each of the plurality of strategic portions are read and write-accessible to a corresponding strategic participant to the exclusion of at least the tactical participant's read and write accessibility.

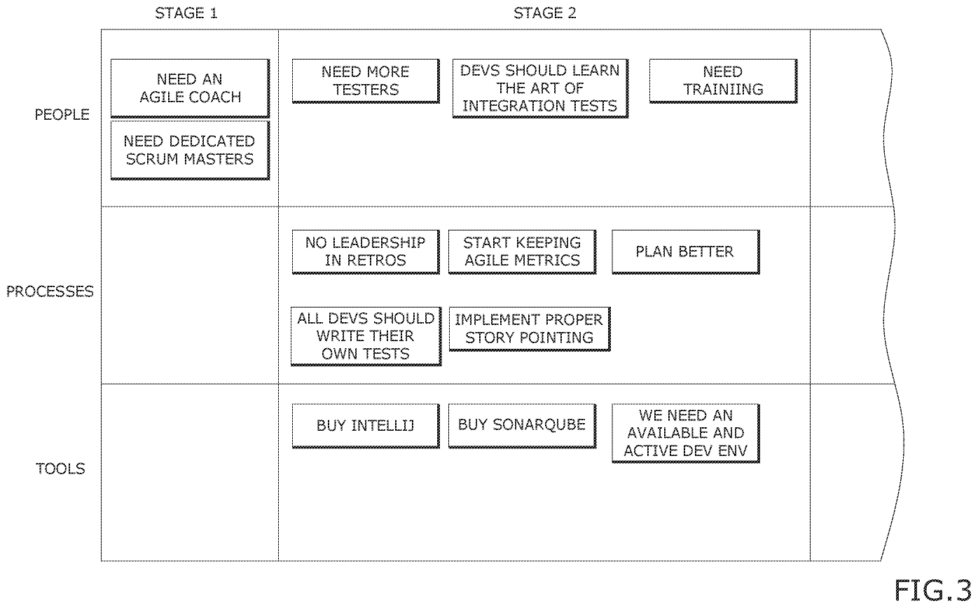

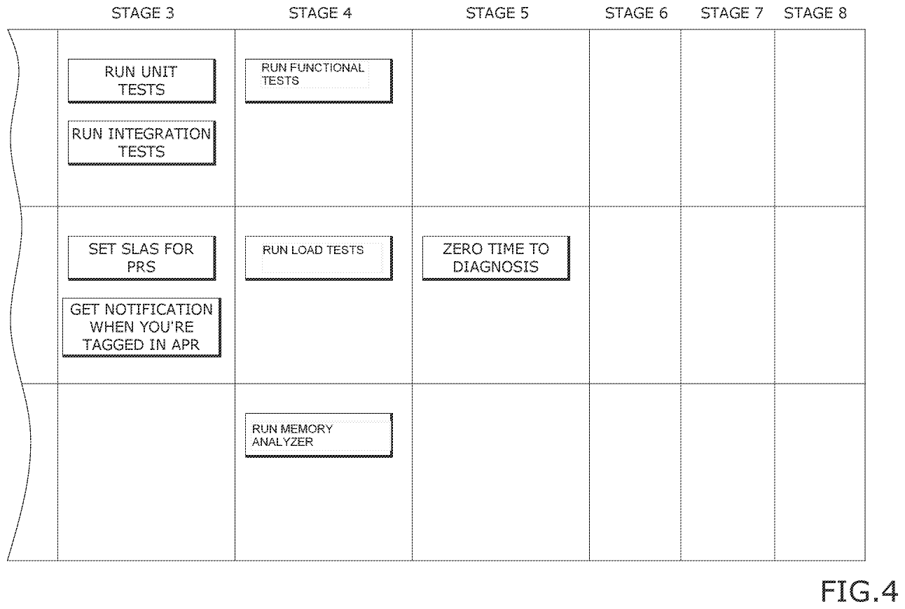

The management framework, through collaborative whiteboarding applications or sessions, enable all the tactical participants to collaboratively input data into a grid called a vision board, as illustrated in FIGS. 3 and 4. The grid may be a graphical control element that presents a tabular view of data, wherein the intersection of each column with each row defines bounded box (or “task boxes”) for inputting tasks on the part of the tactical participants. This vision board will be used to identify the people, processes, and tools necessary to deliver a desired goal through a plurality of production stages that culminate in the desired goal. Strategic participants are discouraged from participating in this vision board phase, thereby encouraging the candid and free flow of ideas from the tactical participants, conventionally defined as the “employees”, “workers”, “contractors”, “engineers”, and the like. Accordingly, in some embodiments, the whiteboarding applications, or a portion thereof, are allocated to the tactical portion of the management framework, and thus read-only accessible to the strategic participants. The strategic participants may be conventionally known as “management”, “leadership”, or the like.

The management framework shown in the Figures may be unique and linked to a specific collaboration environment (e.g., a meeting or project). These objects may be any type of binary data such as a document file (e.g., Word®, PDF), image, audio file, or text. An operatively associated storage mechanism may provide data persistence with read and write access privileges in the form of an access control list of the operatively associated storage mechanism implementation, wherein an implementation may be dictated by behavior rules, such as but not limited to the following: at block 100, the user-participant may then set the other participant's read/write privileges in the form of an access control list. For example, such an access control list may include a plurality of entries, each entry associated with a particular user and/or file, and indicating whether the user has the ability to (i) read, (ii) write, or (iii) read and write to that specific file, wherein the corresponding privilege is added for the user in the access control list.

The present invention is configured to determine whether a user-participant is authorized for write access, for example, by consulting an access control list associated with workspace content.

After whiteboarding, the tactical participants may independently form tactical “pods” within the tactical portion of the management framework. Each tactical pod tends to be groups of similarly skilled tactical participants that will handle tasks aligned with their skills.

In a software development department, for example, after a whiteboarding session, the software engineers (tactical participants) can form a “Front-End engineering (tactical) pod”, to focus solely on the whiteboarding tasks that apply to the front end. The tactical pods should have pod leads that will help coordinate the communication with other tactical pods as well as with corresponding strategic participants (management).

After forming tactical pods, each tactical pod will meet to create tasks using a ticketing system like Atlassian's JIRA. These tickets should work to produce the identified tasks from the whiteboarding phase. These tasks and their tickets should be estimated for effort. Then they will be presented to the corresponding strategic participant—who hitherto would have set strategic objectives that the identified tasks ought to align with. These tasks are then used to track the execution of the work necessary to deliver the needs identified in the whiteboarding application. The strategic objectives can optionally go on the board, inputted by the pod leads who have write-access, not the strategic participants, as they only have read-access. Though in some embodiments, one of the plurality of whiteboarding applications may include a strategic layer that can be write-accessed by the strategic participants, and overlain on the vision board by the pod leads or, in certain embodiments, the strategic participants themselves.

A critical component to the management framework is the assembly board or “vision board:” The vision board includes a grid comprising at least three (3) rows labelled “people”, “processes”, “tools” respectively. Vertically, columns are indicative different production stages the product will go through.

For a software engineering shop working on code, for example, the workspace can have “Development”, “Premerge”, “In repository”, “Post merge” etc., wherein each representing the phases/stages that code will move through for a software product to be delivered to production.

The vision board may reside in the whiteboarding application and thus in the tactical portion, and as such tactical participant populate the grid of the vision board as far as possible for each available product phase/stage, wherein those tactical participants constitute one or more associated tactical pods based on either each tactical participant's interests or skills. Not all the vertical columns of the vision board need to be filled or completed during the whiteboarding phase. The formed pods need to be aligned with aspects of the product being worked on. Pods of tactical participant then align or realign their goals with needs identified on the vision board.

Following the pod formations, each pod may create tracking tickets using task tracking tools like Atlassian's JIRA. The tickets need to describe tasks aligned (in such a way as to measure and identify the tasks' status and delivery) with the tasks described on the vision board. The tickets reside in both tactical and strategic portions and will document the level of effort for these tasks so that they can be prioritized and supported by the corresponding strategic participants.

In certain embodiments, the present invention facilitates a “Shift-Left planning and management methodology,” through computing a score that is an indication of the level of preparedness of the team for delivering the product. Using the tasks input into the vision board, a numerical score will be calculated dynamically in real time—i.e., each time the elements on the vision board are adjusted, the readiness score will be recalculated. This readiness score will then be used as an ongoing guidance mechanism for the team to work towards executing their BMD tasks earlier in the lifecycle of the product.

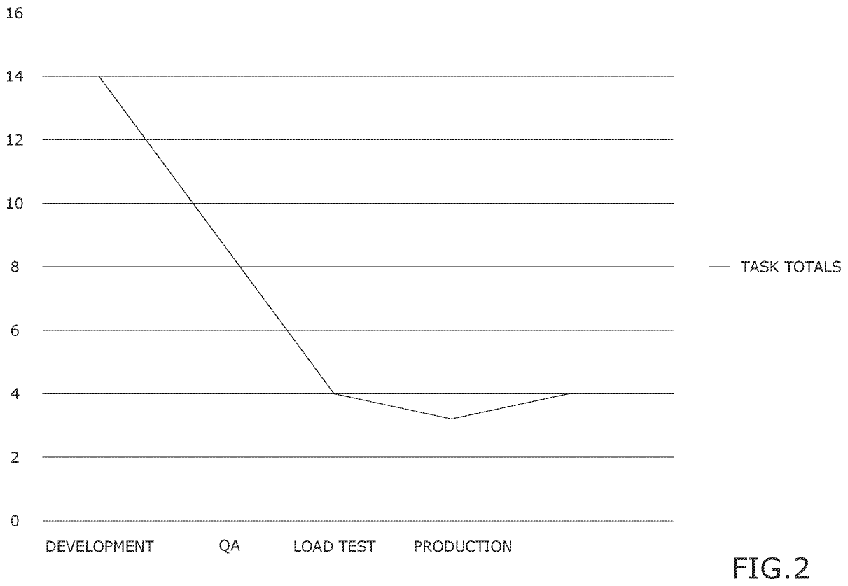

Specifically, after a minimum of three columns in the BMD grid of the vision board have been filled out, a computer system will have enough data to calculate the BMD Readiness Score. This score is achieved thus:
1. Take the stages defined in the BMD grid (the column titles) to be the fixed variables on an X-Y graph. This will put these stages on the X-axis of a hypothetical graph.
2. Take the number of tasks defined per stage on the BMD grid as dependent variables on an X-Y graph. This will put the count of these tasks on the Y-axis of a hypothetical graph.
3. A computer system can then plot the number of tasks per stage on a hypothetical graph. Individual tasks on the board can be excluded from the count of eligible tasks for the computation of the readiness score, as illustrated in FIG. 2. This will help prevent unnecessary skew of tasks that are not deemed relevant to the readiness of the final product. The software system may be designed to select only relevant tasks for inclusion in the calculation of the readiness score by, for instance, marking the task for exclusion or inclusion, in the software system. Only tasks marked for inclusion will be included in the calculation of the readiness score.
   a. The individual task categories or “ingredients,” i.e., people, processes and tools can be plotted individually on the graph to produce a more granular score per ingredient category or grouping.
   b. The computer system may use other available metadata related to the tasks on the board to determine the representation of each task on the graph. A weight score can be assigned to an ingredient that indicates that that ingredient is of a higher significance relative to others in the same production stage of process. An example of the metadata is the level of effort; for instance, a point-based system may be adapted to account for the level of effort involved in delivering a task. Such a points-based scoring could be applied to the tasks on the board, to give them more “weight” relative to other tasks. This weight may then be reflected in the calculation to measurably affect the readiness score.
4. A computer system will then calculate the slope of the virtual graph. A positive slope value i.e., rising from left to right indicates that too much work is being done later in the cycle—an undesirable outcome; a negative slope value indicates that more work is being done earlier on in the lifecycle of the product—the desirable outcome. The computer system will display a hint or tooltip that indicates that the current state of the board is suboptimal, indicating that under the current arrangement of ingredients and tasks may indicate that too much is being done too late in the process. It will recommend a review of the vision board by some means of notification onscreen that the pod reconsider the arrangement of ingredients.

In some embodiments, for the benefit of perception by users of a computer system, the polarity of the slope value may be reversed, i.e., the positive value reversed to become negative, and the negative value being reversed to become positive. This will make for more comfortable understanding of the impact of the BMD Readiness Score, where a positive number is desirable, and a negative number is undesirable. In these embodiments, it is then preferable for users of the computer system to work toward having more tasks leftwards on the BMD grid, so that the computer system displays an increasingly positive number as fewer and fewer tasks become necessary as the BMD grid is filled rightward.

The methods of the management framework may include regular check-in meetings between pod members, regular check-in meetings between pod leadership and organizational leadership (strategic participants), and regular cadence for reviewing the vision board by leadership (strategic participants) and pod members Additionally, a new row could be added to the vision board and named something different. The rows of the grid could be renamed for different “ingredients”, for instance.

The present invention is intended for managing how a product is delivered, and not for delivering of the product itself. For an accounting software shop for example: when they are about to deliver a new software product, a BMD workgroup may be formed comprising the tactical participants that will directly work on the software product. Senior strategic participants may set specific, identifiable, and measurable strategic goals that they need the BMD group to focus on. The tactical participants working on the project will gather and have a whiteboarding session, identifying the people (tactical participants), processes and tools necessary for delivering the latest version of their accounting software. The tactical participants will need to identify these dimensions for every identifiable phase that their code will traverse. After the whiteboarding exercise, the tactical participants can then form pods that will focus on specific tiers of the accounting software. In the pods, during the tasking application, they will create tickets and estimate their level of effort per ticket. These tickets will then be brought forward by the pod leads to corresponding strategic participants. A negotiation follows on the prioritization of the identified tasks for the short and medium term. Once approved by the corresponding strategic participants, the pods will set to work to deliver those tasks in a timely manner. Clear milestones should be defined in working through the ticketed tasks.

The configurable present invention can also facilitate the grooming leaders, improving speed of delivering a product, and improving employee satisfaction and engagement.

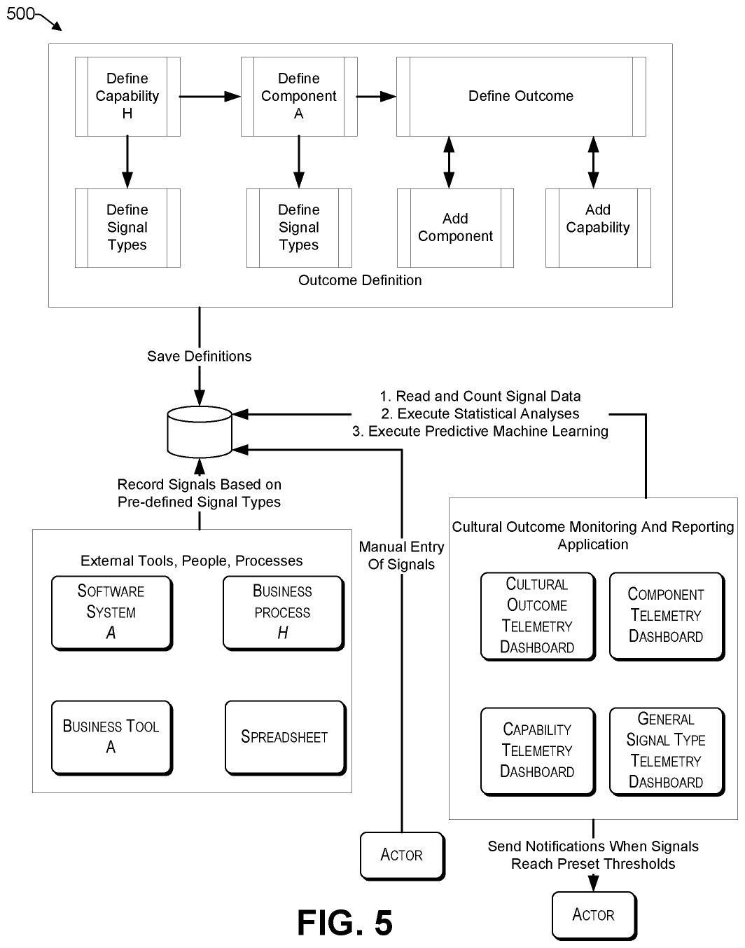

Referring now generally to FIGS. 5-11, another embodiment that provides collaborative production management in an organization is shown. In general, aspects of the subject technology provide a digital software as a service (SaaS) platform for end users within an organization to continuously monitor and nurture the trends and health of the organization's culture. Embodiments includes electronic features that allow an administrative end user to define attributes that will lead to successful outcomes in the projects undertaken within the organization. An “attribute” as used herein is a characteristic related to a project, an organization, or an outcome.

An artificial intelligence (A.I.) and/or machine learning (M.L.) engine is used to predict correlations from different signals about the progression of work within the system based on a current state of attributes. The A.I./M.L. engine may forecast the direction of attributes representing the signals. As will be appreciated, the use of an A.I./M.L. engine to model and forecast the direction of work progression is non-conventional in the field of collaborative management. Conventionally, end users manually graph or predict workplace trends using intuition. Aspects of the subject technology provide administrative end users with a tool to identify counterproductive work progression so that the administrative end users can implement remedies prior to work progression slowing down or running into a problem.

FIG. 5 shows a system 500 that includes a plurality of modules whose data contribute to building an operating one or more digital user interfaces (UIs) for managing the production of workflow and deliverables within the organization. “Actors” as shown may be end users. In some cases, the end users include one or more administrative end users that set up the system 500 for input by the other end users. In one embodiment that provides an example illustrative application of the subject technology, the system 500 may be implemented to define and control outcomes in the organization. “Outcome” as used herein may refer to a long-term perspective that is not marked by a set status or fixed state. Nonetheless, aspects of the subject technology provide directional signals and states of progression toward user defined outcomes within the organization.

For example, one embodiment may include a digital UI that an administrative user can access to define outcomes for the organization. On the back-end of the system 500, an outcome definition module may include a plurality of user defined libraries that define an outcome. A Define Capability library may include parameters that define a capability used to progress toward the outcome. Signal types for a capability may be user added to define a capability. A Define Component library includes files that define tools or other items used to progress toward the outcome. Signal types associated with the components used within the system may be user defined in this library. Once an outcome is defined and actions within the organization occur that contribute toward the outcome progression, the system 500 may continuously adapt by adding new components and capabilities to evaluate the progression. The definitions may be saved to a database (or other file storage mechanism).

The system 500 may include a cultural outcome monitoring and reporting application (referred to generally as the “app”). The app may be configured to electronically display one or more UIs for end user interaction. The app may include for example, a cultural outcome telemetry dashboard, a component telemetry dashboard, a capability telemetry dashboard, and/or a general signal type telemetry dashboard. “Dashboard” as used herein refers to a UI presented on a digital display that shows the current status of one or more features within the system 500. In some embodiments, a computer processor may continuously monitor signals provided by end users contributing toward the project. When an end user contribution or other element is updated in association with the project, the system analyzes the changes in the system 500 affected by the update. In some embodiments, the A.I./M.L. engine may generate prediction models using the definitions and user inputs that update the project. Details of the A.I./M.L. engine aspects are described further below. For example, when an attribute for a project triggers a signal that reaches or crosses a threshold value, the dashboard may display an indicator showing the change in status (whether positive or negative as an indicator). In some embodiments, the predictive modelling may be used to provide guiding information about the state of the project including successful objectives met and/or points in the system 500 that are causing inefficiencies toward the progression of an objective. In some embodiments, the system 500 may be configured to automatically alert the end user of the attribute whose status reached a threshold by sending a notification. In some embodiments, the notification may be displayed automatically in the UI as an overlay or other visual message to gran the end user's attention.

In some embodiments, a module of external tools, people, and processes that may be used by the system 500 toward the progression of the project may include for example, software systems (third party or generally external to the system 500), business processes, external businesses tools, and spreadsheets). Use of elements in the instant module may be factors considered in assessing the cultural health and progression in the system 500.

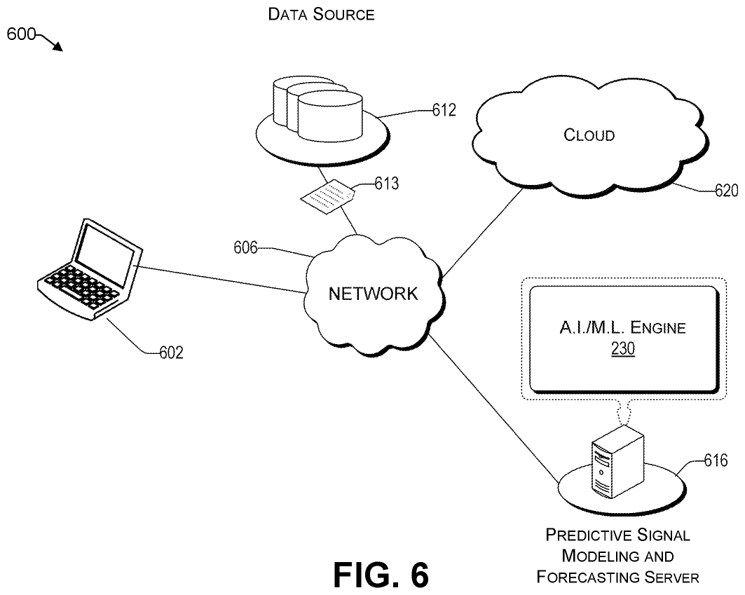

FIG. 6 shows an architecture 600 for predictive modeling correlating the relationship between attributes of a project. Architecture 600 includes a network 606 that allows various computing devices 602 to communicate with each other, as well as other elements that are connected to the network 606, such as data source 612, a predictive signal modeling and forecasting server 616, and the cloud 620. The computing devices 602 and predictive signal modeling and forecasting server 616 may operate under a general computing environment.

The network 606 may be, without limitation, a local area network (“LAN”), a virtual private network (“VPN”), a cellular network, the Internet, or a combination thereof. For example, the network 606 may include a mobile network that is communicatively coupled to a private network, sometimes referred to as an intranet that provides various ancillary services, such as communication with various application stores, libraries, and the Internet. The network 606 allows an A.I./M.L. engine 630, which is a software program running on the predictive signal modeling and forecasting server 616, to communicate with the data source 612, computing devices 202, and/or the cloud 620, to provide data processing of end user inputs, signals automatically generated when triggered by criterium in the system 500, and of data arriving externally of the system 500. In some embodiments, a data packet 613 from the data source 612 may be received by the A.I./M.L. engine 630. This data packet 613 can be received by the A.I./M.L. engine 630 by either a push operation from the database 612 or from a pull operation of the A.I./M.L. engine 630. In one embodiment, the data processing is performed at least in part on the cloud 620. In some embodiments, a direction of the attributes associated with a project may be forecasted by the A.I./M.L. engine 630 based on the prediction model and a current status of progression of work in each sub-category defining an outcome.

While the data source 612 and the A.I./M.L. engine 630 are illustrated by way of example to be on different platforms, it will be understood that in various embodiments, the data source 612 and the predictive signal modeling and forecasting server 616 may be combined. In other embodiments, these computing platforms may be implemented by virtual computing devices in the form of virtual machines or software containers that are hosted in a cloud 620, thereby providing an elastic architecture for processing and storage.

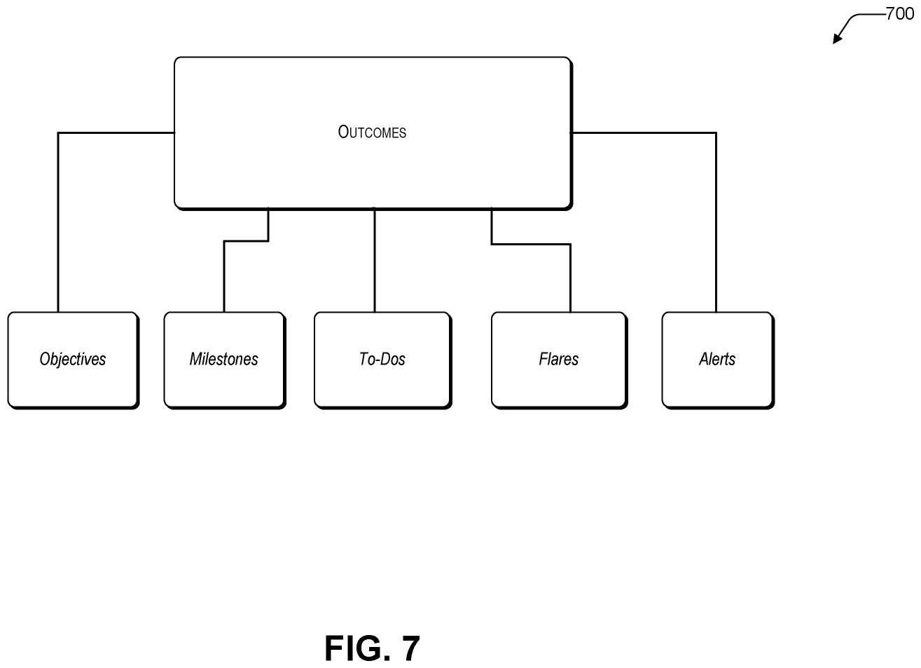

FIG. 7 shows a user defined outcome 700 via schematic representation. In one embodiment, an outcome 700 may be user defined by one or more sub-categories of outcome components. For example, the outcome 700 may include objectives, milestones, tasks (“to-do” lists), flares, and alerts. Parameters that define progression or completion of a state within each of the sub-categories may be input by the administrative end user. As may be appreciated, this aspect of the subject technology allows users to customize how the health and progress of an organization is measured. Parameters may be accompanied by metrics or other definable criteria.

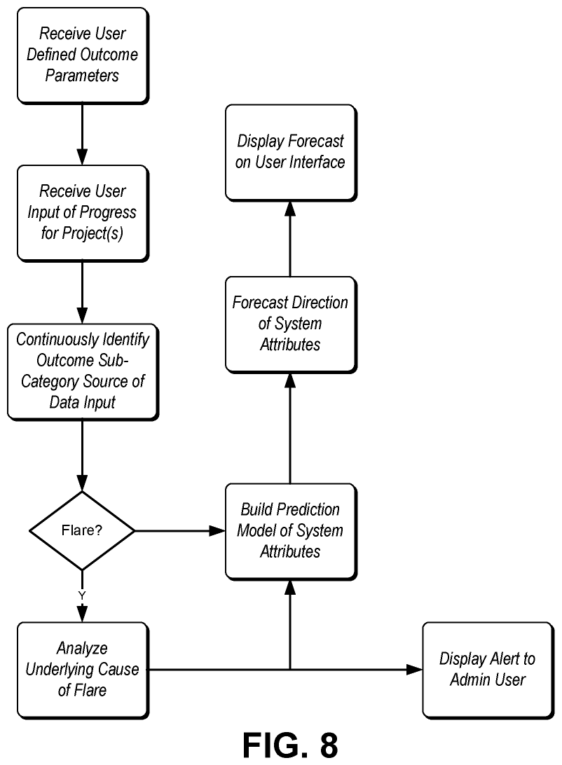

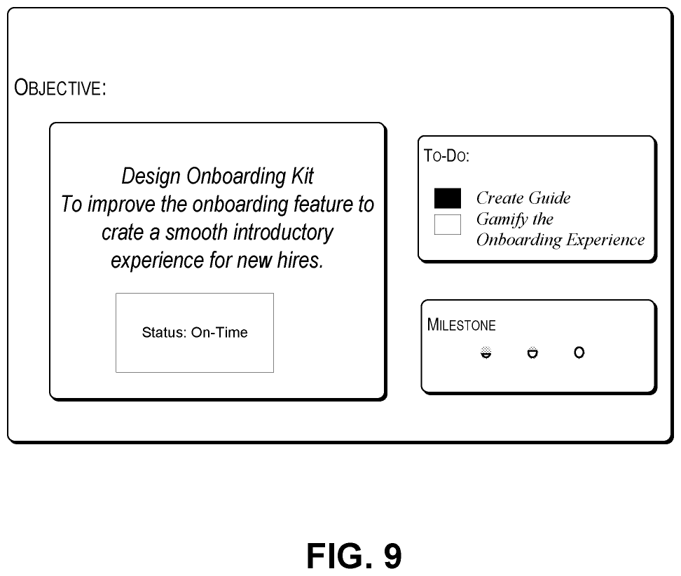

FIG. 8 shows a method of providing collaborative production management in an organization according to an embodiment. The steps in the method may be performed by a computer processor unless noted otherwise. The processor may receive user defined parameters defining an outcome. Referring temporarily to FIG. 9, an example of a UI for defining an outcome is shown according to an example. The objective UI may include a field for receiving a user definition of the objective to be accomplished or progressed within. Some embodiments may include a current status indicator. Some embodiments may include a task list. When a task is selected as completed, the system may automatically update the current state of the project based on how the task completion affected other parts of the system. Some embodiments of the objective UI may include a milestone chart to visually show progress in relation to time.

Referring back to FIG. 8, once the outcome(s) for an organization are defined, other end users may perform tasks or add data to the system that is recorded. The processor may determine how the task and/or data may contribute to the progress of a project. As may be appreciated, the system can consider contributions that are not directly tied to the project or one of its sub-components. Yet, the end user's contribution in one sub-category of an outcome may still indirectly affect progress toward the outcome (whether positively or negatively). For example, a deliverable by an end user toward one task may open the availability of other tasks. Or an action by one end user may raise the business profile of an organization without the end user explicitly trying to raise the profile. The processor may continuously monitor and identify sources of data input for the different sub-categories of an outcome. The sources may be from end users, automatic sub-routines in the back-end of the system, or from entities external to the organization.

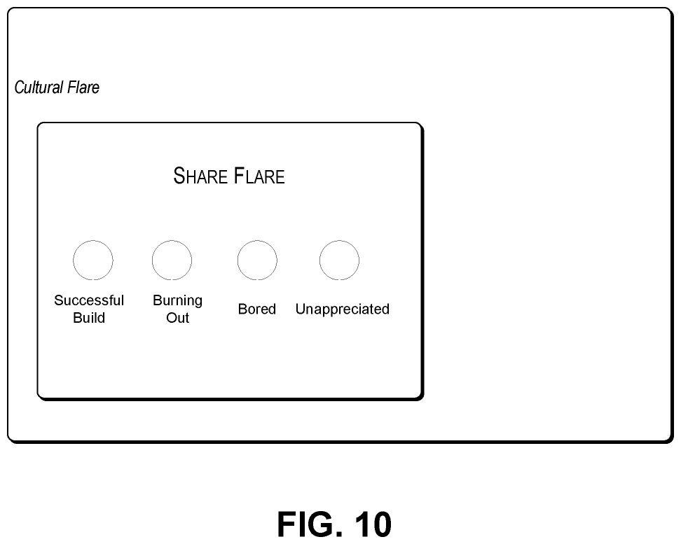

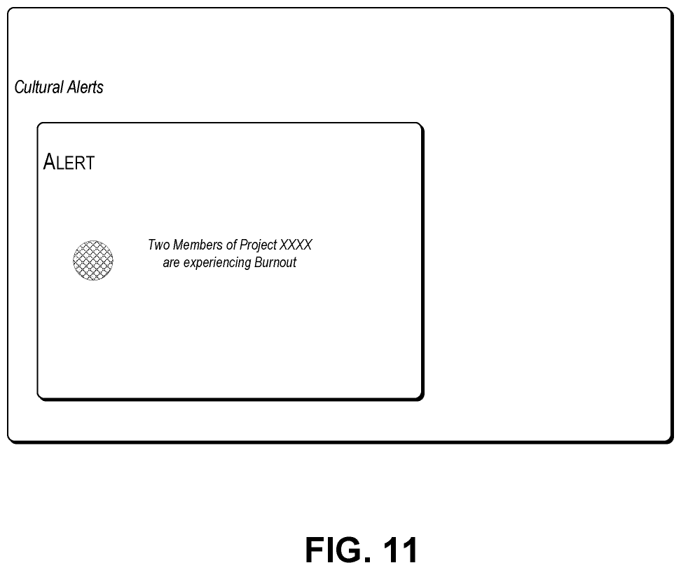

Some embodiments may include a flare feature. A flare may be an internally expressed signal associated with one or more end users participating in a project. As will be appreciated, the flare feature contributes toward the evaluation of an organization or project's health because the flare signal uncovers information that is not generally automatically sent through a system. Moreover, the flare feature may be considered by the A.I/M.L modelling and forecasting as a factor that contributes toward the future state of an outcome, project, or organization's health. During continuous monitoring of the project and user inputs, if a flare is triggered, the processor may analyze the flare to identify an underlying cause. FIG. 10 shows a flare UI that end users can open up from the app. The flare UI provides for example, different selectable icons that represent a current sentiment of the end user. The sentiments may be positive (for example, a successful build has been achieved) or negative/counterproductive (for example, the end user is feeling burned out, bored, or unappreciated.) In some embodiments, when a flare is triggered through a UI, the processor may automatically send an alert to an administrative end user (or other end user with supervisorial status), and example of which can be seen in FIG. 11. An alert may sometimes be provided as an overlay or other prioritized item in any one of the UIs in the app. Multiple flares may be aggregated into an alert so that the administrative end user can use the alert to gauge the current state of health of a project.

Embodiments may include a machine learning module that builds a prediction model based on the current system attributes. The prediction model may be used by the processor to forecast the direction the attributes are headed toward. For example, if a project is showing turnover in participants and/or a new competing company has just opened up, the prediction model may forecast a shortage of labor (the attribute) needed to progress. The system may display the forecast on a digital display so that end users can identify the counterproductive element and prevent the forecast.

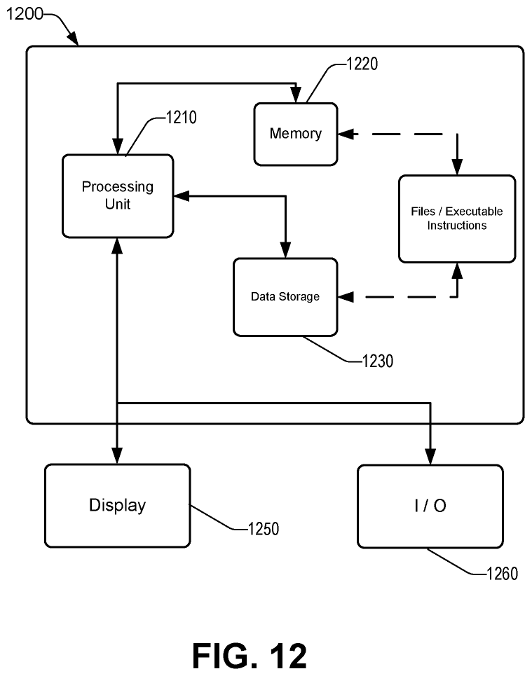

Referring now to FIG. 12, a general computing device 1200 is shown according to an exemplary embodiment. It will be understood that a “computing device” may serve different roles depending on the need in the system or depending on the step being performed in a process. For example, in the role of a platform for providing the SaaS, the computing device 1200 may be a serve or group of servers storing customer information and providing processing service of data input into and consumed within the system 500, for example. In another role, the computing device may be a client device that is configured for end user interaction (for example, to receive user input or view displayed data on the cultural health of the organization or a specific project). In the role of a user device, the computing device 1200 is generally not a server but may instead be desktop computers, tablet or laptop computers, all-in-one computer stations, a mobile computing device (for example, a smart phone, smart wearable devices (glasses, jewelry, watches, ear wear, etc.), smart televisions, smart hubs, robots, or programmable electronics. As will be understood, the end user device may generally provide frontend aspects of the system. In some embodiments however, the frontend computing device may perform one or more of the backend steps where possible. In another role, the computing device 1200 may be a server(s) dedicated to providing artificial intelligence or machine learning processing of data for modelling and forecasting.

The components of the computing device may include, but are not limited to, one or more processors or processing units 1210, a system memory 1220, data storage 1230, a computer program product 1240 having a set of program modules including files and executable instructions, and a bus system that couples various system components including the system memory 1220 to the processor(s) 1210. The memory storage 1220 may store for example, user definitions, sub-routines for executing instructions in response to user defined criteria, software modules for evaluation of outcomes and the current state of system/organization attributes, and software modules for artificial intelligence processing and machine learning.

The computing device 1200 may be described in the general context of computer system executable instructions, such as the program modules which represent a software embodiment of the system and processes described generally above. The program modules generally carry out the functions and/or methodologies of embodiments as described above. The computing device 1200 may typically include a variety of computer system readable media. Such media could be chosen from any available media that is accessible by the computing device 1200, including non-transitory, volatile and non-volatile media, removable and non-removable media for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing. The system memory 1220 could include one or more computer system readable media in the form of volatile memory, such as a random-access memory (RAM) and/or a cache memory. By way of example only, the data storage system 1230 may read from and write to a non-removable, non-volatile magnetic media device. The system memory 1220 may include at least one program product 1240 having a set of program modules that are configured to carry out the functions of embodiments of the invention in the form of computer executable instructions. The program product/utility 1240 may be stored in the system memory 1220 by way of example, and not limitation, one or more application programs, other program modules, and program data. Some embodiments may generate an electronic user interface(s) (viewable and controllable from the display unit 1250) that may allow the user to interact with the app as described above to receive user inputs and/or view dashboard data on the current health and state of an outcome, project, or organization.

The computing device 1200 may communicate with one or more external devices including for example, a peripheral form of the electronic display 1250 which may in some embodiments be configured for tactile response as in a touch screen display. User input into the display 1250 may be registered at the processor 1210 and processed accordingly. Other devices may enable the computing device 1200 to communicate with one or more other computing devices, either by hardwire or wirelessly. Such communication can occur via Input/Output (I/O) interfaces/ports 1260.

The computing device 1200, through the I/O interface/ports 1260, may communicate with one or more networks such as a local area network (LAN), a general wide area network (WAN), and/or a public network (e.g., the Internet, public telephony networks, and DTNs) via a network adapter as is commonly known in the art. Each of the operating system, one or more application programs, other program modules, and program data or some combination thereof, may include an implementation of a networking environment. In some embodiments, the computing device 1200 may be a cloud computing node connected to a cloud computing network. The computing device 1200 may be practiced in distributed cloud computing environments where tasks are performed by remote processing devices that are linked through a communications network. In a distributed cloud computing environment, program modules may be located in both local and remote computer system storage media including memory storage devices.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “module”, “circuit”, or “system.” Furthermore, aspects of the disclosed invention may take the form of a computer program product embodied in one or more computer readable media having computer readable program code embodied thereon. In some embodiments, the output of the computer program product provides an electronic user interface on the display 1250 which may be controlled via direct contact with the display 1250 or via the I/O interfaces 1260 (which may be for example, interface devices such as keyboards, touchpads, a mouse, a stylus, or the like).

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 1210 of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks in the figures.

Those of skill in the art would appreciate that various components and blocks may be arranged differently (e.g., arranged in a different order, or partitioned in a different way) all without departing from the scope of the subject technology. The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

Thus, the claims are not intended to be limited to the aspects shown herein, but are to be accorded the full scope consistent with the language of claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A collaborative production management system, comprising:
a processor; and
a memory coupled to the processor, the memory including program instructions stored thereon that, upon execution by the processor, cause the system to:
create a digital create a digital user interface accessible by a plurality of end users associated with an organization;
receive, from an administrative user of the organization, user defined parameters of a collaborative project outcome, wherein the parameters define sub-categories of attributes associated with a defined success metric of the collaborative project outcome;
receive, by the plurality of end users, input associated with a progression of work within one or more of the sub-categories of topics;
continuously monitor the received input from the plurality of end users;
process the received input from the plurality of end users, using a machine learning modelling module, wherein an operation of the machine learning module includes:
building a prediction model correlating a relationship of the attributes; and
forecasting a direction of the attributes based on the prediction model and a current status of progression of work in each of the sub-categories; and
wherein the program instructions further cause the system to display on the digital user interface:
the current status of progression of work in each of the sub-categories, and the forecasted direction of the attributes.

2. The system of claim 1, wherein the program instructions further cause the system to:
receive, by the processor, a signal from one of the end users, wherein the signal indicates a current sentiment from the end user; and
send an alert to the digital user interface showing the sentiment is being expressed within the organization.

3. The system of claim 2, wherein the alert is displayed anonymously in association with the plurality of end users.

4. The system of claim 2, wherein the sentiment is expressive of counterproductive progression of the work.

5. The system of claim 2, wherein the program instructions further cause the system to:
user;
analyze, by the processor, an underlying cause of the current sentiment from the end forward the analysis to the machine learning module; and
include the analysis in the forecasted direction of the attributes.

6. The system of claim 1, wherein the sub-categories of attributes include objectives, milestones, and tasks to be completed.

7. A computer program product for providing collaborative production management in an organization, the computer program product comprising:
one or more computer readable storage media, and program instructions collectively stored on the one or more computer readable storage media, the program instructions comprising:
creating a digital create a digital user interface accessible by a plurality of end users associated with an organization;
receiving, from an administrative user of the organization, user defined parameters of a collaborative project outcome, wherein the parameters define sub-categories of attributes associated with a defined success metric of the collaborative project outcome;
receiving, by the plurality of end users, input associated with a progression of work within one or more of the sub-categories of topics;
continuously monitoring the received input from the plurality of end users;
processing the received input from the plurality of end users, using a machine learning modelling module, wherein an operation of the machine learning module includes:
building a prediction model correlating a relationship of the attributes; and
forecasting a direction of the attributes based on the prediction model and a current status of progression of work in each of the sub-categories; and
wherein the program instructions further cause the system to display on the digital user interface:
the current status of progression of work in each of the sub-categories, and the forecasted direction of the attributes.

8. The computer program product of claim 7, wherein the program instructions further comprise:
receiving, by the processor, a signal from one of the end users, wherein the signal indicates a current sentiment from the end user; and
sending an alert to the digital user interface showing the sentiment is being expressed within the organization.

9. The computer program product of claim 8, wherein the alert is displayed anonymously in association with the plurality of end users.

10. The computer program product of claim 8, wherein the sentiment is expressive of

11. counterproductive progression of the work. The computer program product of claim 8, wherein the program instructions further comprise:
analyzing, by the processor, an underlying cause of the current sentiment from the end user;
forwarding the analysis to the machine learning module; and
including the analysis in the forecasted direction of the attributes.

12. The computer program product of claim 7, wherein the sub-categories of attributes include objectives, milestones, and tasks to be completed.

13. A method providing collaborative production management in an organization, comprising:
creating a digital create a digital user interface accessible by a plurality of end users associated with an organization;
receiving, from an administrative user of the organization, user defined parameters of a collaborative project outcome, wherein the parameters define sub-categories of attributes associated with a defined success metric of the collaborative project outcome;
receiving, by the plurality of end users, input associated with a progression of work within one or more of the sub-categories of topics;
continuously monitoring the received input from the plurality of end users;
processing the received input from the plurality of end users, using a machine learning modelling module, wherein an operation of the machine learning module includes:
building a prediction model correlating a relationship of the attributes; and
forecasting a direction of the attributes based on the prediction model and a current status of progression of work in each of the sub-categories; and
wherein the program instructions further cause the system to display on the digital user interface:
the current status of progression of work in each of the sub-categories, and the forecasted direction of the attributes.

14. The method of claim 13, further comprising:
receiving, by the processor, a signal from one of the end users, wherein the signal indicates a current sentiment from the end user; and
sending an alert to the digital user interface showing the sentiment is being expressed within the organization.

15. The method of claim 14, wherein the alert is displayed anonymously in association with the plurality of end users.

16. The method of claim 14, wherein the sentiment is expressive of counterproductive progression of the work.

17. The method of claim 14, further comprising:
analyzing, by the processor, an underlying cause of the current sentiment from the end user;
forwarding the analysis to the machine learning module; and
including the analysis in the forecasted direction of the attributes.

18. The method of claim 13, wherein the sub-categories of attributes include objectives, milestones, and tasks to be completed.
